(19) United States
(12) Patent Application Publication
(10) Pub. No.: US 2008/0223672 A1
(43) Pub. Date: Sep. 18, 2008

(54) Vehicle damper of variable damping force

(75) Inventors: Nobuharu Kuriki, Saitama (JP); Hiromi Inagaki, Saitama (JP); Yuichi Okada, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/075,363

(22) Filed: Mar. 11, 2008

(30) Foreign Application Priority Data
Mar. 13, 2007 (JP) 2007-063851
Jul. 23, 2007 (JP) 2007-190745

(51) Int. Cl. F16F 9/19

(52) U.S. Cl. 188/317

(57) ABSTRACT

A damper of variable damping force adapted to be built into a vehicular suspension is disclosed. The damper has frictional force generating means for applying a frictional force to a rod. The frictional force generating means is disposed at one end of a cylinder and positioned externally of the latter.

### FIELD OF THE INVENTION

The present invention relates to a vehicle damper of variable damping force adapted to be built into a vehicular suspension, which utilizes friction, for varying a damping force of the damper.

### BACKGROUND OF THE INVENTION

In a variable damping force damper of this type, for example, an orifice is formed in a piston, and a damping force is generated by the resistance that arises when oil flows through the orifice. The variation in the damping force is generally accomplished by varying the diameter of the orifice so that the flow rate of the oil flowing through the orifice is varied.

However, for example, a variable damper which is devised so that the damping force of the damper is varied using an electromagnet is known from Japanese Patent Application Laying-Open Publication No. 11-2276 (JP 11-002-276 A) as another type of a damper of variable damping force.

Below, the variable damping force damper disclosed in JP 11-002-276 A will be described with reference to FIGS. 11 and 12 hereof.

As is shown in FIGS. 11 and 12, the variable damping force damper 300 is constructed from a tubular cylinder 301, a piston 302 that moves through this cylinder 302, damper oil 304 that flow through the cylinder 301 via an orifice 303 formed in this piston 302, a rod 306, one end of which is attached to the piston 302, and the other end of which protrudes to the outside of the cylinder 301 via a rod guide 305, and two (upper and lower) friction generating means 308 and 309 which are accommodated inside the cylinder 301, and which are attached to the rod 306.

The upper friction generating means 308 has an electromagnet 311 which is attached to the rod 306, an annular plate 312 which is attracted to this electromagnet 311, a cam surface 313 which is formed with an inclination on the electromagnet 311, and a shoe member 316 which contacts this cam surface 313 via a plurality of balls 314, and which has a plurality of segments 315 attached to the annular plate 312 so as to allow movement in the direction of diameter of the cylinder 301.

When the electromagnet 311 is excited and the annular plate 312 is attracted to the electromagnet 311, the balls 314 run over the cam surface 313, so that the segments 315 are moved outward in the radial direction of diameter of the cylinder 301 by the balls 314, and the shoe member 316 is caused to contact the inside surface of the cylinder 301. A frictional force is generated by the contact between this shoe member 316 and the inside surface of the cylinder 301, and the damping force of the damper varies. The lower friction generating means 309 has the same construction as the upper friction generating means 308.

However, in the variable damping force damper 300, the shoe members 316 are disposed in a space (inside the cylinder 301) in which the piston 302 is accommodated. Accordingly, the damper oil 304 is interposed between the shoe members 316 and the inside surface of the cylinder 301. Consequently, the damper oil 304 enters the space between the shoe members 316 and the inside surface of the cylinder 301, and it is difficult to generate a sufficient frictional force.

Furthermore, the damper 300 that has a variable damping force has a structure which has two fraction generating means comprising an upper friction generating means 308 in which a frictional force is generated when a force is applied to the damper from above, and a lower friction generating means 309 in which a frictional force is generated when a force is applied to the damper from below; accordingly, the structure is complicated.

### SUMMARY OF THE INVENTION

It is an object of the present invention to provide a damper of variable damping force for use in a vehicle which can block the effects of the damper oil, and which has friction generating means of simple structure.

According to a first aspect of the present invention, there is provided a damper of variable damping force for use in a vehicle, which comprises: a tubular cylinder; a piston reciprocally movable within the cylinder and demarcating an interior of the cylinder into two compartments; a rod attached to the piston and protruding to outside from one end of the cylinder via a rod guide; damper oil sealed inside the cylinder and capable of flowing through the two compartments via a plurality of orifices formed in the piston; and friction generating means for applying a frictional force to the rod, the friction generating means being disposed at one end of the cylinder and positioned externally of the cylinder.

Since the friction generating means is disposed on the outside of the cylinder, this can also easily be mounted on a damper which has a conventional structure. As a result, the all-purpose use of the friction generating means can be promoted.

Preferably, the friction generating means comprises: a plurality of shoe members disposed around the rod for applying a frictional force to the rod; a moving plate formed of a magnetic material; a cam member for moving the shoe members toward an outer circumferential surface of the rod; an electromagnetic coil for moving the shoe members toward an axial center of the rod by chucking the moving plate; and a compression coil spring for urging the shoe members in a direction opposite a direction of chucking of the electromagnetic coil. Owing to the spring, a single friction generating means can be used in the pushing direction of the damper and in the pulling direction of the damper. As a result, the structure is simplified compared to a case where two friction generating means are used.

According to a second aspect of the present invention, there is provided a damper of variable damping force for use in a vehicle, which comprises: a tubular cylinder; a piston reciprocally movable within the cylinder and demarcating an interior of the cylinder into two compartments; a rod attached to the piston and protruding to outside from one end of the cylinder via a rod guide; damper oil sealed inside the cylinder and capable of flowing through the two compartments via a plurality of orifices formed in the piston; friction generating means for applying a frictional force to the rod; and dividing means for dividing the interior of the cylinder, the friction generating means being disposed in a space divided and formed between the dividing means and the rod guide.

Thus, the damper oil is prevented from permeating the divided spaces by the dividing means, and the effect of the damper oil can be blocked. As a result, the desired frictional force can be applied by the friction generating means.

Desirably, oil having a lower viscosity than the damper oil is sealed inside the divided spaces. If the viscosity of this oil is thus low, the oil can easily spread through the entire divided space in each case; the frictional force of the friction generating means can be made uniform, and the frictional force can be kept within a specified friction range.

According to a third aspect of the present invention, there is provided a damper of variable damping force for use in a vehicle, which comprises: a tubular cylinder; a piston capable of reciprocal movement within the cylinder and demarcating an interior of the cylinder into two compartments; a rod attached to the piston and protruding to outside from an interior of the cylinder; damper oil sealed inside the cylinder and capable of flowing through the two compartments via a plurality of orifices formed in the piston; and friction generating means for applying a frictional force to the rod, the friction generating means being disposed at an end of the cylinder from which the rod protrudes.

Since the friction generating means is disposed on the end part of the cylinder where the rod protrudes to the outside from the inside of the cylinder, the friction generating means can also be caused to perform a rod guiding function. As a result, the variable damping force damper can be compactly constructed.

### BRIEF DESCRIPTION OF THE DRAWINGS

Certain preferred embodiments of the present invention will be described in detail below, by way of example only, with reference to the accompanying drawings, in which:

FIG. 1 is a sectional view showing a damper unit using a damper of variable damping force according to a first embodiment;

FIG. 2 is an enlarged sectional view of a friction generating means shown in FIG. 1;

FIGS. 3A and 3B are plan views showing a plurality of shoe members of the friction generating means of FIG. 2;

FIGS. 4A and 4B are schematic views showing an operation of the friction generating means of FIG. 2;

FIG. 5 is a graph showing an example variation in the damping force characteristics of the variable damping force damper shown in FIG. 1;

FIG. 6 is a graph showing an example variation in the damping force characteristics in a case where a very small amplitude is excited in the variable damping force damper shown in FIG. 1;

FIG. 7 is a sectional view of a damper unit using a damper of variable damping force according to a second embodiment;

FIG. 8 is an enlarged view of FIG. 7;

FIG. 9 is a sectional view of a damper unit using a damper of variable damping force according to a third embodiment;

FIG. 10 is an enlarged view of FIG. 9;

FIG. 11 is a sectional view showing a conventional damper of variable damping force; and

FIG. 12 is an enlarged view of the b region FIG. 11.

### DESCRIPTION OF THE PREFERRED EMBODIMENTS

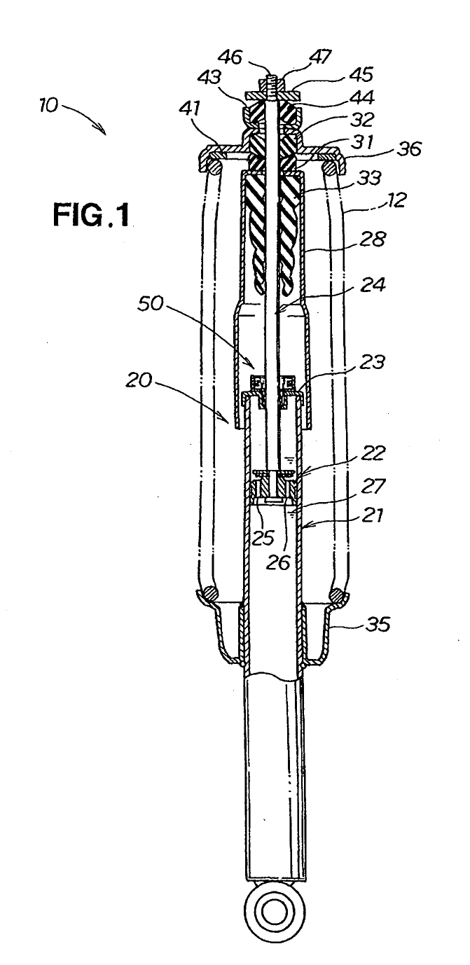

Referring initially to FIG. 1, the damper unit 10 has a damper of variable damping force (shock absorber) 20 and a coil spring 12.

The damper of variable damping force 20 comprises a tubular cylinder 21, a piston 22 which moves through this cylinder 21, and which demarcates the interior of the cylinder 21 into two compartments, a rod 24 which is attached to this piston 22, and which protrudes upward from one end of the cylinder 21 via a rod guide 23, damper oil 27 which is sealed inside the cylinder 21, and which flows through the two compartments via orifices 25 and 26 formed in the piston 22, and friction generating means 50 which generates a frictional force between the cylinder 21 and the piston 22. The rod 24 and cylinder 21 are covered by a tubular cover 28.

The tubular cover 28 is supported on the rod 24 via first and second damper rubbers 31 and 32, and a damper rubber 33 inside the cover.

The coil spring 12 is disposed between a first receiving member 35 attached to the cylinder 21, and a second receiving member 36 positioned on the tip end part of the rod 24. A spring-receiving washer 41, the rod side receiving member 36, a dish-form washer 43, an outer damper rubber 44, and a flat washer 45 are engaged in that order on the tip end part of the rod 24. The tip end part of the rod 24 is formed as a screw part 46, and a nut 47 is screwed onto this screw part 46.

The damper of variable damping force 20 is constructed from a cylinder 21, a piston 22, a rod 24 which protrudes via a rod guide 23, damper oil 27 which flows through two compartments via orifices 25 and 26, and friction generating means 50 which generates friction between cylinder 21 and the piston 22. The friction generating means 50 is disposed on one end of the cylinder 21 on the outside of the cylinder 21. Accordingly, this can also be easily mounted on a damper having a conventional structure, and the all-purpose use of the friction generating means 50 can be promoted.

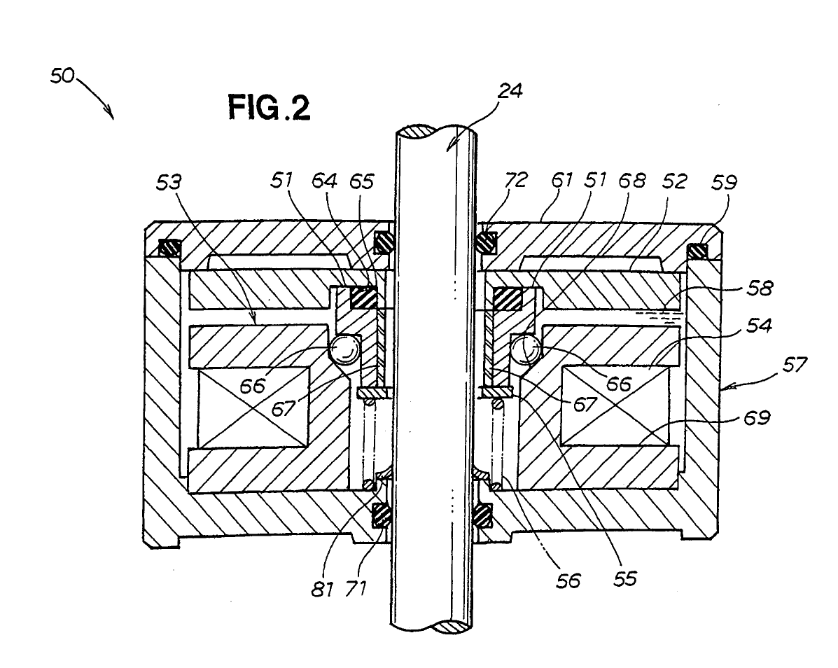

Furthermore, since an oil 58 having a lower viscosity than the damper oil 27 (see FIG. 2) is sealed inside the friction generating means 50, the low-viscosity oil can easily spread throughout; the frictional force of the friction generating means 50 can be made more uniform, and the frictional force can be kept within a specified friction range.

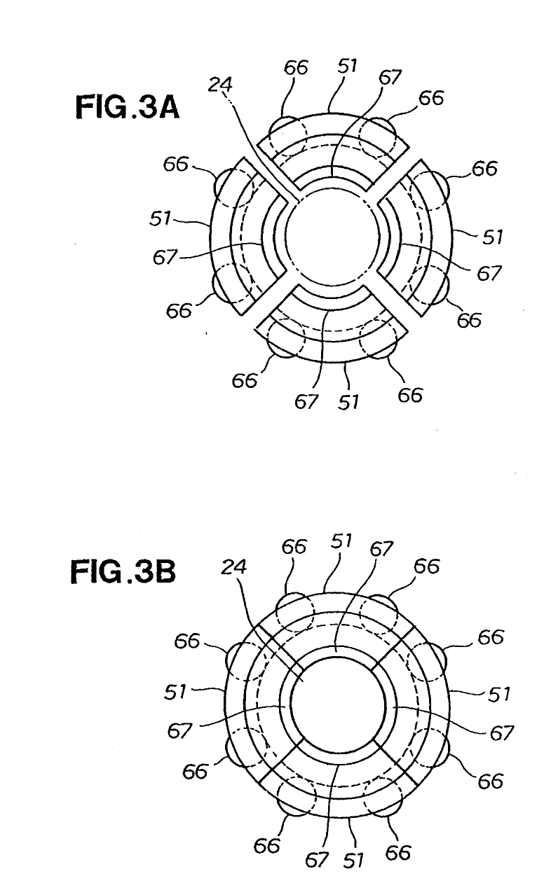

FIG. 2 shows the friction generating means 50 shown in FIG. 1, FIG. 3A shows a state in which the shoe members 51 is expanded in diameter, and FIG. 3B shows a state in which the shoe members 51 is contracted in diameter.

As shown in FIG. 2, the friction generating means 50 has a plurality of shoe members 51 which is disposed around the rod 24, and which applies a frictional force to the rod 24, a moving plate 52 formed of a magnetic material which causes the shoe members 51 to move downward, a cam member 53 which causes the shoe members 51 to move in the central axial direction of the rod 24 when this moving plate 52 has moved downward, an electromagnetic coil 54 which attracts the moving plate 52 so that the moving plate 52 moves downward, a compression coil spring 56 which urges the shoe members 51 so as to provide resistance in the direction of attraction of the electromagnetic coil 54 via a washer 55, a case 57 which accommodates the shoe members 51, the moving plate 52, the cam member 53, and the electromagnetic coil 54, and a cover 61 which seals the oil 58 having a lower viscosity than the damper oil 27 inside the case 57 via an oil seal 59.

As is shown in FIG. 2, FIG. 3A, and FIG. 3B, the shoe members 51 is supported inside an annular recess 64 formed in the moving plate 52 via an elastic member 65, and is supported on the cam member 53 via a plurality of balls (steel spheres) 66 so that movement is possible in the vertical direction and horizontal direction.

A guide groove (not shown) is formed in the shoe members 51 or the cam member 53 so that each of the balls 66 is prevented from moving loosely.

The shoe members 51 has pads 67 for each shoe member.

The cam member 53 has a bobbin part 69 of a magnetic material around which the electromagnetic coil 54 is wound, and an inclined cam surface 68 which is formed on this bobbin part 69. Each of the balls 66 is interposed between the respective shoe members 51 and the inclined cam surface 68.

The case 57 supports the rod 24 via an oil ring 71 so that sliding is possible. The cover member 61 supports the rod 24 via an oil ring 72 so that sliding is possible.

Since the friction generating means 50 has a compression coil spring 56, a single friction generating means 50 can be used in the pushing direction of the damper, and in the pulling direction of the damper. As a result, the structure can be made simpler than in a case where two friction generating means are used.

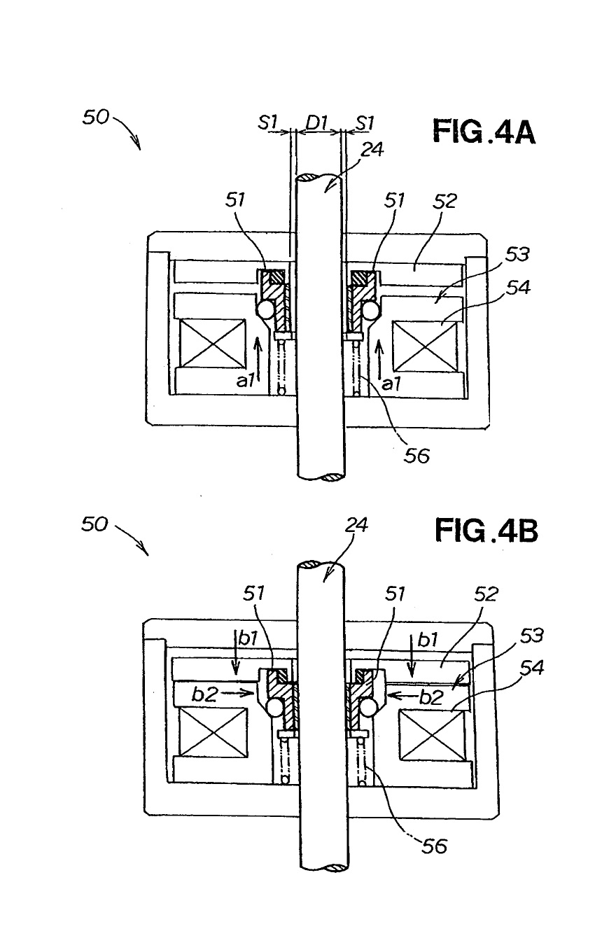

FIGS. 4A and 4B show the operating state of the friction generating means 50 shown in FIG. 2.

As shown in FIG. 4A, when the electromagnetic coil 54 is in a non-excited state, the shoe members 51 is lifted upward by the compression coil spring 56 as indicated by the arrows a1, a1, and the shoe members 51 is in a state of non-contact on the outer circumferential surface of the rod 24. Specifically, if D1 is the diameter of the rod 24, the shoe members 51 is in a state in which gaps S1, S1 are maintained with respect to the rod 24. Accordingly, the rod 24 is in a state of non-friction with respect to the shoe members 51.

As shown in FIG. 4B, when the electromagnetic coils 54 is excited, the moving plate 52 is attracted against the force of the compression coil spring 56 as indicated by the arrows b1, b1. As is also indicated by FIG. 3B, the shoe members 51 is compressed in diameter by the cam member 53 as shown by arrows b2, b2, and contacts the outer circumferential surface of the rod 24. As a result, a frictional force is generated in the in the rod 24. By adjusting the voltage that excites the electromagnetic coil 54, it is possible to adjust the magnitude of the frictional force that is generated in the rod 24.

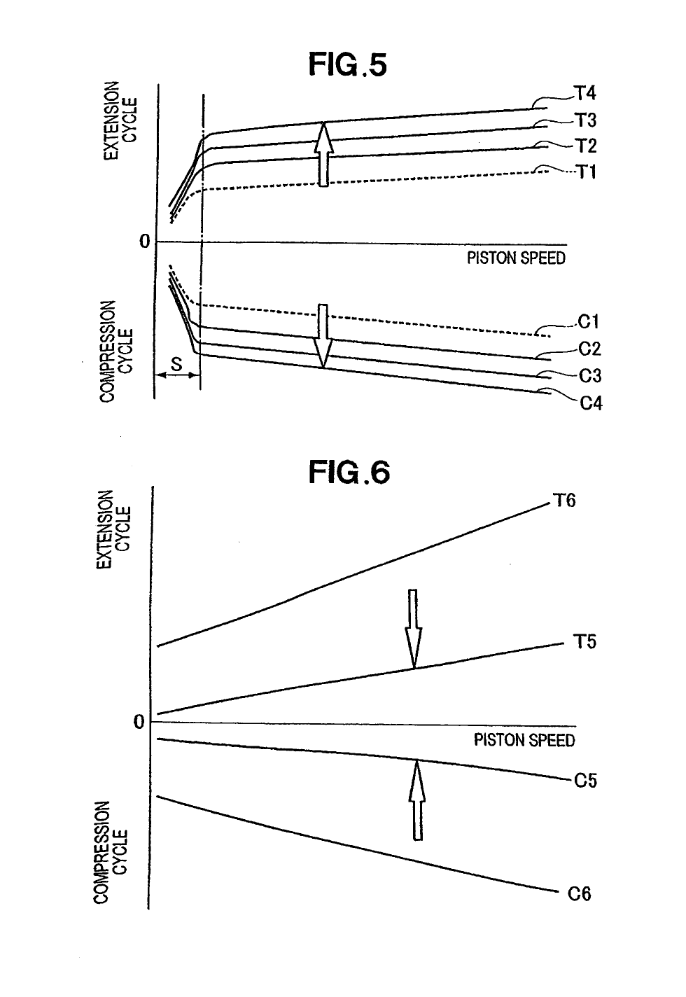

FIG. 5 is a graph showing one example of the variation of the damping force characteristics of the damper of variable damping force 20 shown in FIG. 1. The horizontal axis shows the piston speed, and the vertical axis shows the damping force of the extension cycle and compression cycle of the damper.

The broken line T1 shows the damping force characteristics with respect to the piston speed in the extension cycle of the damper in a state in which the electromagnetic coil 54 is not excited. The broken line C1 shows the damping force characteristics with respect to the piston speed in the compression cycle of the damper in a state in which the electromagnetic coil 54 is not excited. Specifically, the broken lines T1 and C1 show the damper characteristics according to only the flow of the damper oil 27 as in a conventional damper.

The solid lines T2, T3, and T4 show the damping force characteristics with respect to the piston speed in the extension cycle of the damper when the electromagnetic coil 54 is excited. The relationship P2<P3<P4 is established with P2 being the power (or voltage) of the solid line T2, P3 being the power (or voltage) of the solid line T3, and P4 being the power (or voltage) of the solid line T4. Specifically, as the voltage that excites the electromagnetic coil 54 increases, the frictional force of the rod 24 also increases. In other words, the damping force in the extension cycle of the damper increases as shown by the solid lines T2, T3, and T4.

The solid lines C2, C3, and C4 show the damping force characteristics with respect to the piston speed in the contraction cycle of the damper when the electromagnetic coil 54 is excited. The relationship P2<P3<P4 is established with P2 being the power (or voltage) of the solid line C2, P3 being the power (or voltage) of the solid line C3, and P4 being the power (or voltage) of the solid line C4. Specifically, as the voltage that excites the electromagnetic coil 54 increases, the frictional force of the rod 24 also increases. In other words, the damping force in the contraction cycle of the damper increases as shown by the solid lines C2, C3, and C4.

With the variable damping force damper 20, it is possible to effectively switch the roll rigidity and damping characteristics of the vehicle during ordinary operation by controlling the friction generating means 50. Furthermore, a stable frictional force can be obtained using the friction generating means 50, and the stability of damping force control can also be improved. In addition, there is no hindrance of damping force control by the friction generating means 50 in the very low speed region S of approximately 0.1 m/sec, either.

FIG. 6 is a graph showing one example of the variation in the damping force characteristics in a case where a very small amplitude is excited in the damper of variable damping force for use in a vehicle shown in FIG. 1. The horizontal axis shows the piston speed, and the vertical axis shows the damping force in the extension cycle and compression cycle of the damper.

The broken line T5 shows the damping force characteristics with respect to the piston speed in the extension cycle of the damper in the case of a state in which the electromagnetic coil 54 in a very small excitation amplitude region of the piston 22 and a very low piston speed is not excited; characteristics which rise to the right are shown. Adjustment as shown by the solid line T6 can be accomplished by causing the friction generating means to generate a frictional force.

The broken line C5 shows the damping force characteristics with respect to the piston speed in the contraction cycle of the damper in the case of a state in which the electromagnetic coil 54 in a very small excitation amplitude region of the piston 22 and a very low piston speed is not excited; characteristics which descend to the right are shown. Adjustment as shown by the solid line C6 can be accomplished by causing the friction generating means to generate a frictional force.

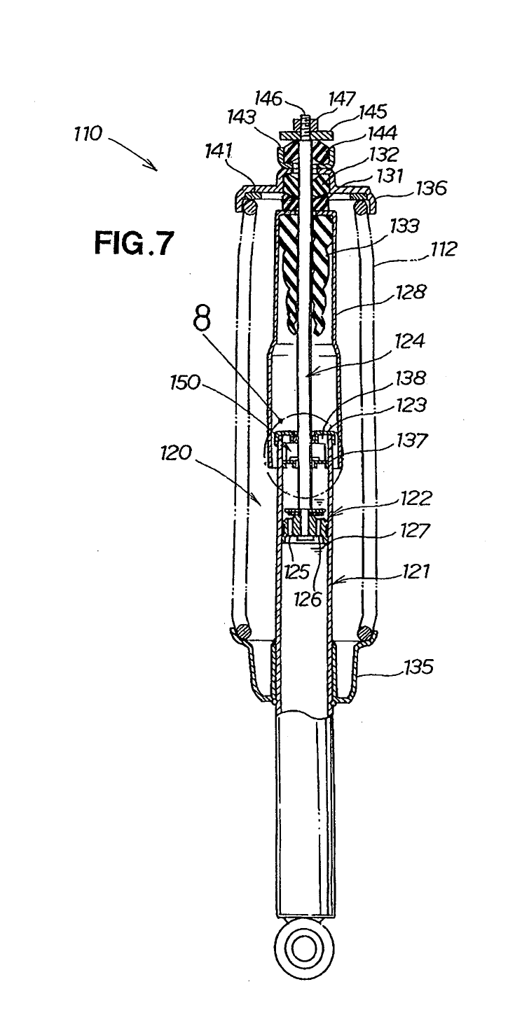

FIG. 7 shows a damper unit 110 using a damper of variable damping force 120 according to a second embodiment. Members which are the same in the damper unit 10 of the first embodiment shown in FIGS. 1 and 2 and the variable damping force damper 120 are indicated by the same reference numbers, and a detailed description of such members is omitted.

The damper unit 110 has the variable damping force damper 120 (shock absorber) and a coil spring 112.

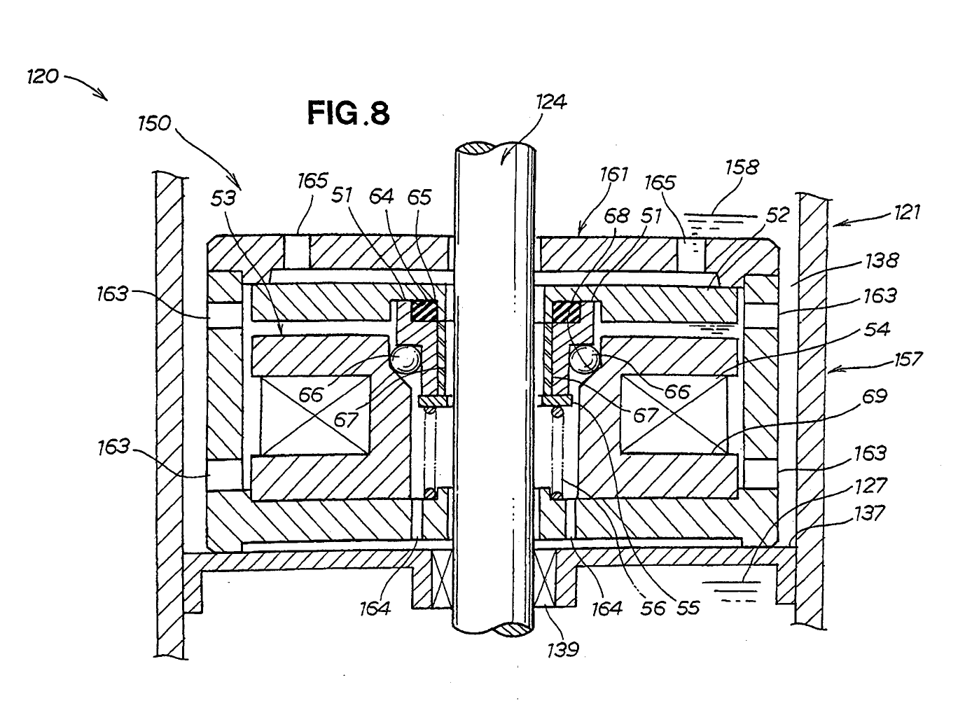

The variable damping force damper 120 according to the second embodiment comprises a tubular cylinder 121; a piston 122 which is attached to this cylinder 121 so that sliding is possible, performs a reciprocating movement through the cylinder 121, and demarcates the cylinder 121 into two compartments; a rod 124 which is attached to this piston 122, and which protrudes to the outside of the cylinder 121 from one end of the cylinder 121 via a rod guide 123; damper oil 127 which is sealed inside the cylinder 121, and which flows through the two compartments via a plurality of orifices 125 and 126 formed in the piston 122; dividing means 137 which divides the interior of the cylinder 121 in order to prevent any ingress of the damper oil 127; friction generating means 150 which is disposed in the space 138 divided by this dividing means 137, and which generates a frictional force in the rod 124; an oil 158 which has a lower viscosity than the damper oil 127 (see FIG. 8), and which is sealed inside the divided space 138; and a tubular cover 128 which is supported on the side of the rod 124, and which covers the rod 124 and cylinder 121.

In the dividing means 137, the divided space 138 is sealed by the sealing member 139 shown in FIG. 8.

The tubular cover 128 is supported on the rod 124 by first and second damper rubbers 131 and 132, and a damper rubbed 133 inside the cover.

The coil spring 112 is disposed between a cylinder side receiving member 135 attached to the cylinder 121, and a rod side receiving means 136 interposed on the tip end of the rod 124. A spring receiving washer 141, the rod side receiving member 136, a dish-form washer 143, an outer damper rubber 144, and a flat washer 145 are engaged in the stated order on the tip end part of the rod 124. A nut 147 is screwed onto a screw part 146 formed on the tip end part of the rod 124.

The friction generating means 150 shown in FIG. 8 has a plurality of shoe parts 51 which is disposed around the rod 124, and which applies a frictional force to the rod 124, a moving plate 52 formed of a magnetic material, a cam member 53, an electromagnetic coil 54 which causes the shoe members 51 to move in the direction of the axial center of the rod 124 by attracting the moving plate 52, a spring member 56 which urges the shoe members 51 via a washer 55 in the direction opposing the direction of attraction of the electromagnetic coil 54, a case 157 which accommodates the shoe members 5 1, the moving plate 52, the cam member 53, and the electromagnetic coil 54, and a cover 161 which covers this case 157.

The case 157 has a plurality of oil flow-through holes 163 and a plurality of oil flow-through holes 164 through which the low-viscosity oil 158 flows. The cover 161 has a plurality of oil flow-through holes 165 through which the low-viscosity oil 158 flows.

In the variable damping force damper 120, the dividing means 137 that divides the interior of the cylinder 121 is disposed in order to prevent invasion by the damper oil 127, and the friction generating means 150 is disposed in the space 138 divided by this dividing means 137. Accordingly, the effects of the damper oil 127 can be blocked. As a result, the desired frictional force can be applied by the friction generating means 150.

Since oil 158 having a lower viscosity than the damper oil 127 is sealed inside the divided space 138, the frictional force of the friction generating means 150 can be made more uniform, and the frictional force can be kept within the desired friction range.

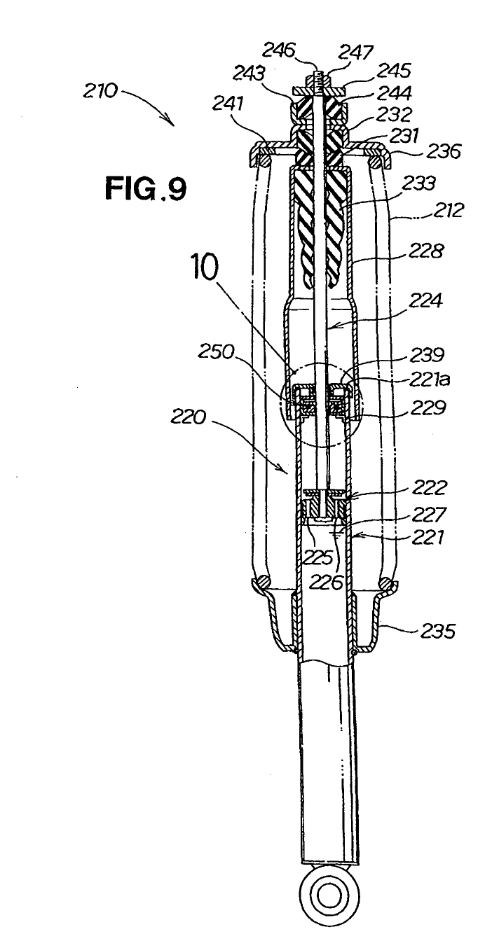

FIG. 9 shows a damper unit using a damper of variable damping force according to a third embodiment. Parts which are the same as parts used in the damper unit 10 shown as the first embodiment are identified with the same symbols, and a detailed description of such part is omitted.

Referring to FIG. 9, the damper unit 210 has a damper (shock absorber) of variable damping force 220 and a coil spring 212.

The variable damping force damper 220 according to the third embodiment comprises a tubular cylinder 221, a piston 222 which performs a reciprocating movement through this cylinder 221, and which demarcates the cylinder 221 into two compartments, a rod 224 which is attached to this piston 222, and which protrudes from the end part of the cylinder 221, damper oil 227 which is sealed inside the cylinder 221, and which flows through the two compartments via a plurality of orifices 225 and 226 formed in the piston 222, friction generating means 250 which is disposed on the end part inside the cylinder 221, and which also has a guide function that guides the rod 224, friction generating means 250 which generates a frictional force in the rod 224, and a tubular cover 228 which is supported on the rod 224, and which covers the rod 224 and cylinder 221.

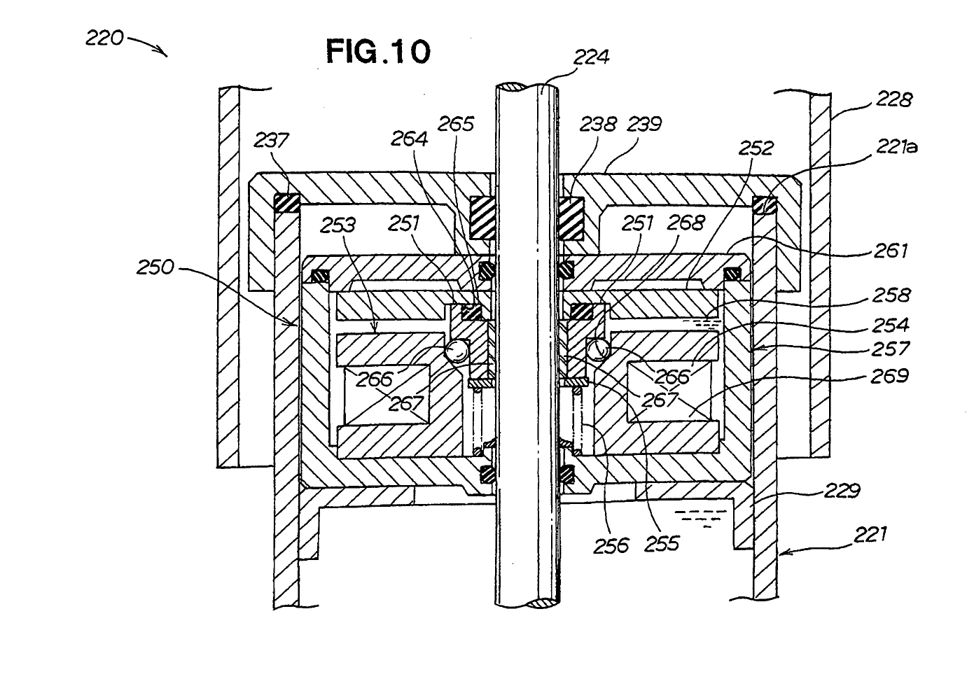

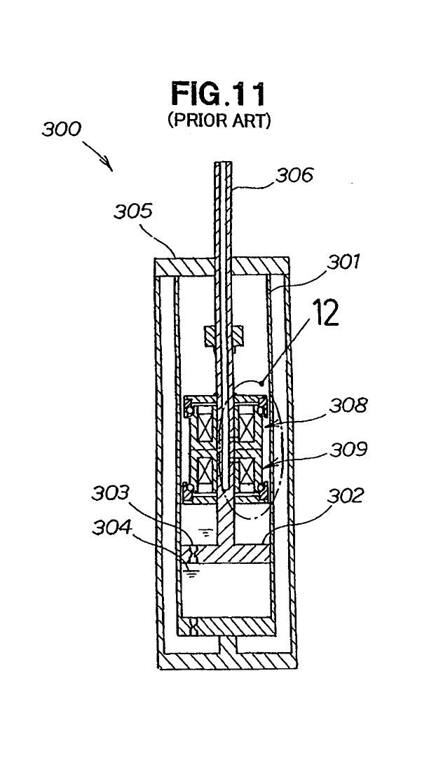

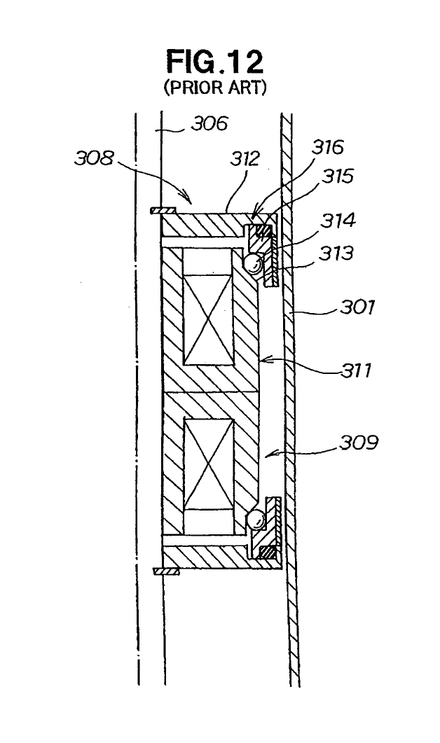

As is shown in FIG. 10, the upper end 221 a of the cylinder 221 is covered by a cap 239 via an oil seal 237. An oil seal 238 is interposed between the cap 239 and the rod 224.

The friction generating means 250 is disposed on a supporting stay 229.

The tubular cover 228 is supported on the rod 224 by first and second damper rubbers 231 and 232, and a damper rubber 233 inside the cover.

The coil spring 212 is disposed between a cylinder side receiving member 235 attached to the cylinder 221, and a rod side receiving member 236 interposed on the tip end of the rod 224. A spring receiving washer 241, the rod side receiving member 236, a dish-form washer 243, an outer damper rubber 244, and a flat washer 245 are engaged in that order on the tip end part of the rod 224. A nut 247 is screwed onto a screw part 246 formed on the tip end part of the rod 224.

Referring to FIG. 10, the friction generating means 250 has a plurality of shoe members 251 which is disposed around the rod 224, and which guides the rod 224, and applies a frictional force to the rod 224, a moving plate 252 formed of a magnetic material, a cam member 253 which causes the show members 251 to move toward the axial center of the rod 224, an electromagnetic coil 254 which causes the shoe members 251 to move toward the axial center of the rod 224 by attracting the moving plate 252, a spring member 256 which urges the shoe members 251 in the direction of attraction of the electromagnetic coil 254 and in the opposite direction via a washer member 255, a case 257 which accommodates the shoe members 251, moving plate 252, cam member 253, and magnetic coil 254, and a cover 262 which covers this case 257.

The shoe members 251 has members that have substantially the same construction as the shoe members 51 shown in FIG. 2. This plurality of shoe members 251 has a guiding function that guides the rod 224 in a manner that allows sliding when the electromagnetic coil 254 is in a non-excited state, and has members that apply a specified frictional force to the rod 224 when the electromagnetic coil 254 is excited.

The shoe members 251 is supported via an elastic member 265 inside a recess 264 formed in the moving plate 252, and is supported on the cam member 253 so that sliding is possible in the vertical direction and the horizontal direction via a plurality of balls (steel spheres) 266.

Each of the shoe members 251 has a pad 267.

The cam member 253 has a cam surface 268 that supports the balls 266, and a bobbin part 269 formed of a magnetic material around which the electromagnetic coil 254 is wound.

The oil 258 having a lower viscosity than the damper oil 227 is sealed inside the case 257; this makes it possible to make the frictional force of the friction generating means 250 more uniform, and to keep the frictional force within a specified friction range.

The variable damping force damper 220 is constructed from a cylinder 221, a piston 222, a rod 224 which protrudes to the outside from the cylinder 221, damper oil 227 which flows through the two compartments via orifices 225 and 226, and friction generating means 250 which generates a frictional force between the cylinder 221 and the piston 222; this friction generating means 250 is disposed on the upper end part of the cylinder 221 from which the rod 224 is extended.

Specifically, since the friction generating means 250 is disposed on the upper end part of the cylinder 221 from which the rod 224 is extended, the friction generating means 250 can be caused to perform a rod guiding function as well. As a result, the variable damping force damper 220 can be constructed in a compact manner.

In the variable damping force damper 20 according to the first embodiment, as is shown in FIG. 2, the oil 58 having a lower viscosity than the damper oil 27 is sealed inside the case 57, and a cover 61 is installed via an oil seal 59. However, the present invention is not limited to this; a construction in which this low-viscosity oil is not sealed may also be used.

In the variable damping force damper 20, as is shown in FIG. 2, a lip 81 may also be provided in order to improve the sealing characteristics.

In the variable damping force damper 20, as is shown in FIG. 2, the cam member 53 is formed of a magnetic material, and has a cam surface 68 that supports the balls 66, and a bobbin part 69 around which the electromagnetic coil 54 is wound. However, the present invention is not limited to this; the cam surface and bobbin part may also be separately formed as separate parts.

The variable damping force damper according to the present invention is suitable for use in passenger vehicles such as sedans, wagons and the like.

Obviously, various minor changes and modifications of the present invention are possible in light of the above teaching. It is therefore to be understood that within the scope of the appended claims the invention may be practiced otherwise than as specifically described.

1. A damper of variable damping force for use in a vehicle, comprising:
a tubular cylinder;
a piston reciprocally movable within the cylinder and demarcating an interior of the cylinder into two compartments;
a rod attached to the piston and protruding to outside from one end of the cylinder via a rod guide;
damper oil sealed inside the cylinder and capable of flowing through the two compartments via a plurality of orifices formed in the piston; and
a friction generating mechanism which applies a frictional force to the rod, the friction generating mechanism being disposed at one end of the cylinder and positioned externally of the cylinder.

2. The damper of claim 1, wherein the friction generating mechanism comprises:
a plurality of shoe members disposed around the rod for applying a frictional force to the rod;
a moving plate formed of a magnetic material;
a cam member for moving the shoe members toward an outer circumferential surface of the rod;
an electromagnetic coil for moving the shoe members toward an axial center of the rod by chucking the moving plate; and
a compression coil spring for urging the shoe members in a direction opposite a direction of chucking of the electromagnetic coil.

3. A damper of variable damping force for use in a vehicle, comprising:
a tubular cylinder;
a piston reciprocally movable within the cylinder and demarcating an interior of the cylinder into two compartments;
a rod attached to the piston and protruding to outside from one end of the cylinder via a rod guide;
damper oil sealed inside the cylinder and capable of flowing through the two compartments via a plurality of orifices formed in the piston;
a friction generating mechanism which applies a frictional force to the rod; and
a dividing mechanism which divides the interior of the cylinder, the friction generating mechanism being disposed in a space divided and formed between the dividing mechanism and the rod guide.

4. The damper of claim 3, wherein oil having a viscosity lower than that of the damper oil is sealed in the divided space.

5. The damper of claim 3, wherein the friction generating mechanism comprises:
a plurality of shoe members disposed around the rod for applying a frictional force to the rod;
a moving plate formed of a magnetic material;
a cam member for moving the shoe members toward an outer circumferential surface of the rod;
an electromagnetic coil for moving the shoe members toward an axial center of the rod by chucking the moving plate; and
a compression coil spring for urging the shoe members in a direction opposite a direction of chucking of the electromagnetic coil.

6. A damper of variable damping force for use in a vehicle, comprising:
a tubular cylinder;
a piston capable of reciprocal movement within the cylinder and demarcating an interior of the cylinder into two compartments;
a rod attached to the piston and protruding to outside from an interior of the cylinder;
damper oil sealed inside the cylinder and capable of flowing through the two compartments via a plurality of orifices formed in the piston; and
a friction generating mechanism which applies a frictional force to the rod, the friction generating mechanism being disposed at an end of the cylinder from which the rod protrudes.
